(19) United States
(12) Patent Application Publication
(10) Pub. No.: US 2013/0327631 A1
(43) Pub. Date: Dec. 12, 2013

(54) ROTARY EVAPORATOR

(71) Applicants: Erwin Hauser, Emmendingen (DE); Erich Becker, Bad Krozingen (DE)

(72) Inventors: Erwin Hauser, Emmendingen (DE); Erich Becker, Bad Krozingen (DE)

(73) Assignee: KNF Neuberger GmbH, Freiburg (DE)

(21) Appl. No.: 14/000,692

(22) PCT Filed: Jul. 25, 2012
(86) PCT No.: PCT/EP2012/003146

§ 371 Date: Aug. 21, 2013

(30) Foreign Application Priority Data
Oct. 8, 2011 (DE) 20 2011 1060534.4

(51) Int. Cl. B01D 3/08

(52) U.S. Cl. CPC B01D 3/085
USPC 202/238

(57) ABSTRACT

A rotary evaporator (1), having an equipment stand (2) with a protruding guide tower (3), a glass structure (4) which has an evaporation tank (5) and can be displaced on the guide tower (3) for lifting and lowering the evaporation tank (5) thereof, and at least one fluid line that is connected to the glass structure (4). In one embodiment, the guide tower (3) has a channel (17) that is oriented in the longitudinal extension of the tower (3) and in which a line section is provided of at least one fluid line that is connected to the glass structure (4) and opens out into or ends in a flexible tube connection. This flexible tube connection is arranged on a bottom-side region of the rotary evaporator, which faces away from the free end of the guide tower (3), and the glass structure (4) is retained on a carriage (21) that can be displaced laterally on the guide tower (3). In another embodiment of the invention, the carriage (21) can be displaced from a lifting position against a return force into a lowering position, and a stationary winch (35) located opposite the guide tower (3) is provided for displacing the carriage (21), said winch comprising at least one rope (37) that can be wound up and is retained or guided on the carriage (21).

### BACKGROUND

The invention relates to a rotary evaporator with an appliance stand, on which a guide tower projects, with a glass superstructure which has an evaporation vessel and which, for the raising and lowering of, in particular, its evaporation vessel, is held on a carriage which is movable laterally on the guide tower, and with at least one fluid line which is connected to the glass superstructure.

Rotary evaporators are already known in various versions. Such rotary evaporators are intended for the careful separation of liquid mixtures and solutions, using the different boiling points of the components. Thus, rotary evaporators will also be used for drying, for solvent recovery and for similar processes. What usually serves as an evaporator element is a heating bath containing a heated water or oil volume. An evaporator piston rotates in the heated water or oil quantity of the heating bath and in the interior of its piston contains the solution to be evaporated. This solution is distributed to the heated piston inner walls of the rotating evaporator piston as a thin liquid film which can easily evaporate there. As a result of the rotation of the evaporator piston, a delay in boiling is also avoided, and, in conjunction with the heating bath, a homogeneous temperature distribution is achieved in the medium to be evaporated. The additionally caused full mixing of the heating bath makes it appreciably easier to regulate the effective heating temperature. To avoid high temperatures which entail risks for the user and will also give rise to unwanted chemical reactions in the medium, the evaporation process is assisted by an evacuation of the process space. The evaporator performance is varied by means of the heating bath temperature, the piston size and the rotational speed of the evaporator piston and also the set vacuum pressure. Due to the general inertia of the temperatures of the medium and process, evaporation is primarily controlled at constant temperatures via the pressure. So that the process space can be evacuated and so that the necessary coolant inflows and outflows can be connected to the required cooler, at least one hose connection and usually a plurality of hose connections is provided on the rotary evaporator glass superstructure surrounding the evaporator piston and are connected in each case via a flexible hose line to a vacuum pump or to a coolant inflow or outflow.

Over the past decades, the operability, reliability, and automation of previously known rotary evaporators were substantially improved. However, some disadvantages can occasionally be found.

The previously known rotary evaporators have an appliance stand on which a guide tower projects. The guide tower has an inner tower part of rectangular cross section which encases an outer tower part raisable and lowerable in relation to the inner tower part. The glass superstructure, also comprising the evaporator piston, is held on the outer tower part of the guide tower and can be positioned in a vertical direction by the outer tower part being raised and lowered. The glass superstructure is connected via mostly a plurality of flexible hose lines to a vacuum pump and to a coolant inflow and outflow.

Thus, a rotary evaporator with an appliance stand, on which a guide tower projects, is also already previously known from U.S. Pat. No. 5,152,375. The previously known rotary evaporator has a glass superstructure with an evaporation vessel, and, for the raising and lowering of, in particular, the evaporation vessel of the glass superstructure, the latter is held on a carriage which is movable laterally on the guide tower. In this previously known rotary evaporator, too, the glass superstructure is connected via a plurality of flexible fluid lines to a vacuum pump and to a coolant inflow and outflow.

In the previously known rotary evaporators, the length of the hose lines has to be dimensioned generously, so that the hose lines have sufficient length at any height of the glass superstructure. However, when the rotary evaporator is being handled, the hose lines led around the rotary evaporator and the glass superstructure held on its guide tower may cause an obstruction and entail the risk that the user of the rotary evaporator inadvertently becomes entangled in these hose lines. Since the relative position of the inner and the outer tower part can often also only be estimated, the processes and the associated parameters of the rotary evaporator may possibly not be readily reproducible.

The German utility model DE 93 16 757 U1 already discloses a pump stand with a baseplate which serves as a carrier and on which a pump, a control unit and, if appropriate, further accessories are fastened. Also provided on the baseplate is a holding arm, on which a vacuum controller and/or a separator are/is held. The baseplate and the holding arm have cavities and perforations, so that not only electrical lines, but also pneumatic connections, such as, for example, hoses, can be led through the baseplate and the holding arm. Such hoses can therefore be led from the pump fastened on the baseplate through the baseplate and the holding arm to the upper free end of the holding arm, so that the hose can be connected freely to the vacuum controller there.

Although the pump stand previously known from DE 93 16 757 U1 has already belonged to the prior art for nearly two decades, this previously known prior art has not been able to influence the design of rotary evaporators. In such rotary evaporators, the requisite fluid lines, even today, are still laid freely, so as not to impair the movement of raising and lowering the glass superstructure connected to these hose lines.

### SUMMARY

The object, therefore, is to provide a rotary evaporator which can be operated simply and safely.

In the rotary evaporator of the type initially mentioned, the solution according to the invention for achieving this object is that the guide tower has a duct which is oriented in the longitudinal extent of the tower and in which is provided a line portion of at least one fluid line which is connected to the glass superstructure and which issues or ends in a hose connection which is arranged on a bottom-side region, facing away from the free end of the guide tower, of the rotary evaporator, but, for this purpose, the guide tower is formed from at least two profile portions which are connected to one another in a parting position oriented in the longitudinal extent of the guide tower, that the guide tower has at least one profile portion which is designed as a hollow profile, and that at least one hollow profile inner space of at least one profile portion forms the duct of the guide tower.

In the rotary evaporator according to the invention, tower parts one encasing another and which can be raised and lowered in relation to one another may be dispensed with. Instead, in the rotary evaporator according to the invention, the glass superstructure is held on a carriage which can be moved laterally on the guide tower. Since the guide tower therefore always has a constant tower height, the tower interior of the guide tower can be utilized in order to lead therein at least one line portion of a hose line connected to the glass superstructure. For this purpose, the guide tower has a duct which is oriented in the longitudinal extent of the tower and in which the line portion of the at least one fluid line connected to the glass superstructure is provided. The at least one fluid line connected to the glass superstructure issues or ends in a hose connection which is arranged on a bottom-side region, facing away from the free end of the guide tower, of the rotary evaporator. The fluid line can be connected there, for example, to a vacuum pump in the usual way. Since a comparatively long line portion of the at least one fluid line is led, protected, inside the guide tower, and since the line portions remaining in the region of the glass superstructure can therefore be kept comparatively short, these cause less obstruction, and also the risk of inadvertent entanglement in these line portions is markedly reduced. Also as a result of this, inter alia, the rotary evaporator according to the invention can be operated simply and safely.

In order to make the production and assembly of the rotary evaporator according to the invention substantially simpler, there is provision whereby the guide tower is formed from at least two profile portions which are connected to one another preferably releasably in a parting position oriented in the longitudinal extent of the guide tower. The guide tower has at least one profile portion which is designed as a hollow profile and in which at least one hollow profile inner space or at least one profile portion forms the duct of the guide tower.

It is possible to lead a flexible hose line connected by one hose end to a glass superstructure through the duct provided in the guide tower, in order to connect the other hose end of this hose line to the bottom-side hose connection. In a preferred version according to the invention, however, there is provision whereby at least one line portion provided in the guide tower is connected at its line portion end facing away from the bottom-side first hose connection to a second hose connection which is arranged at the free end region of the guide tower. In this preferred embodiment, a preferably flexible hose piece is provided between the glass superstructure and the second hose connection. The fluid line leaves from there, via its line portion arranged in the duct of the guide tower, to the bottom-side hose connection.

It is possible to lead the air to be sucked away or the coolant required in a cooler directly via the duct of the guide tower, said duct being designed, for example, as a hollow profile inner space. However, so that various lines can also be led, protected, via only one duct, it is expedient if at least one line portion, provided in the duct of the guide tower, of the at least one fluid line is designed as a hose line led in the duct, and if this line portion is connected at its hose line ends to the first and, if appropriate, to the second hose connection.

In a preferred development according to the invention, there is a provision whereby at least two profile portions of the guide tower delimit a cavity which is designed to be open at a guide slot, whereby a carriage guide, on which the carriage is guided movably, is provided in the cavity, and whereby the carriage carries at least one connecting arm passing through the guide slot and connected to the glass superstructure. In this developing embodiment, the carriage guide is accommodated, protected, in a cavity delimited by at least two profile portions. Guided on the carriage guide located in the cavity is a carriage carrying at least one connecting arm which is connected to the glass superstructure. For this purpose, the at least one connecting arm passes through a guide slot which is provided laterally on the guide tower.

In a structurally especially simple embodiment according to the invention which can be produced comparatively easily, there is provision whereby the guide slot is arranged, in the parting position, between at least two profile portions and is delimited by adjacent narrow margins of these profile portions.

In order to make an appliance superstructure reproducible more easily and in order thereby to simplify the handling of the rotary evaporator according to the invention, it is advantageous if the carriage can be positioned by means of a scaling having a scale which is provided on the outer circumference of the guide tower and which cooperates with an indicator located on the carriage.

In a preferred development according to the invention, there is provision whereby the carriage can be moved from a raised position counter to a restoring force into a lowered position, and whereby, for the movement of the carriage, a rope winch is provided which is fixed with respect to the guide tower and which has at least one windable rope held or guided on the carriage.

According to this inventive proposal, for moving the carriage on the guide tower, a rope winch is provided which is fixed with respect to the carriage and which has at least one windable rope held or guided on the carriage. The rope winch used as a lifting drive is comparatively quiet, this being especially advantageous in laboratory work. Since a transmission of force takes place by rope in this rope winch, substantial decoupling of the possibly even high-vibration motor from the remaining structure of the rotary evaporator is possible. The rope winch can be placed at a suitable location, and the rope can be led to the carriage via at least one deflection. The rope is held or guided on the carriage in such a way that, by the rope being wound up or unwound and by the rope portion which projects beyond the rope winch being shortened or lengthened, the carriage can be raised by the restoring force or can be lowered counter to the restoring force. In the event of a power failure, the rope winch releases the rope wound on it, in such a way that the restoring force can move the carriage into the raised position; since, in the event of a power failure, the carriage is thus moved automatically into its raised position in which the evaporation vessel is located at a distance above the heating bath, the process taking place in the evaporation vessel is interrupted as a precaution and uncontrolled overheating of the liquid to be evaporated is reliably prevented.

So that the speed at which the carriage is moved on the guide tower can be adapted to the rotational speed of the drive motor used for the rope winch, and/or so that a comparatively heavy glass superstructure can also be moved easily on the guide tower with the aid of a small drive motor, it is advantageous if the at least one rope of the rope winch is guided via a pulley block.

So as not to transmit the vibrations of the drive motor to the structure of the rotary evaporator, in a preferred embodiment according to the invention there is provision whereby the rope winch has a drive motor having a sprung or vibration-damping mounting.

So that the drive motor does not impede the return movement of the carriage caused by the restoring force in the event of a power failure, it is advantageous if the rope winch has a drive motor which is designed as an electric drive motor torque-free in the currentless state.

The travelling movement of the carriage and its positioning at a defined lift height are made easier if the rope winch has a drive motor which is designed as a stepping motor.

In a compact and advantageous embodiment according to the invention, there is provision whereby at least one gas pressure spring is provided as the restoring force.

The restoring force exerted by the gas pressure spring can move the carriage and raise it into a defined raised position, even in the event of a power failure, when the at least one gas pressure spring presses the carriage against a sliding stop in the raised position.

### BRIEF DESCRIPTION OF THE DRAWINGS

Further features of the invention will be gathered from the following description of an exemplary embodiment according to the invention in conjunction with the claims and the drawing. The individual features can be implemented in each case in themselves or severally in an embodiment according to the invention.

In the drawing:

FIG. 1 shows a rotary evaporator which is shown in an overall perspective illustration and has an appliance stand on which a guide tower projects, a carriage which serves as a holding device being movable laterally on the guide tower and carrying a glass superstructure with an evaporation vessel capable of dipping into a temperature control vessel, and the evaporation vessel being assigned a rotary drive which causes the evaporation vessel to rotate about its longitudinal axis in the temperature control vessel,

FIG. 2 shows the guide tower of the rotary evaporator shown in FIG. 1 in a perspective cross-sectional illustration,

FIG. 3 shows a lifting drive which is shown in a diagrammatic illustration as an individual part and is arranged in the guide tower which is intended for moving the carriage, serving as a holding device, on the guide tower,

FIG. 4 shows the carriage, illustrated in longitudinal section, which can be moved on the guide tower and carries the glass superstructure, there being provided on the carriage a rotary drive which is pivotable about a horizontal pivot axis and by means of which the evaporation vessel of the glass superstructure can be rotated in the temperature control vessel of the rotary evaporator,

FIG. 5 shows the guide tower from FIGS. 2 to 4, as a detail, in a perspective view in the region of the carriage, where scaling on the guide tower for indicating the lift height and scaling on the carriage for indicating the pivot angle selected for the rotary drive can be seen,

FIG. 6 shows the rotary drive from FIG. 4 in longitudinal section, the rotary drive having a hub which can be driven in rotation and which passes through a vapor leadthrough designed as a hollow glass shaft, the hollow glass shaft carrying the evaporation vessel at one shaft end and issuing with its other shaft end in a connection piece leading to a cooler, and the rotational movement of the rotary-drivable hub of the rotary drive being transmitted to the hollow glass shaft by means of a sleeve-shaped clamping insert which is pushed onto the hollow glass shaft,

FIG. 7 shows the rotary drive from FIGS. 4 and 6 as a detail in longitudinal section in the region of the clamping insert pushed onto the hollow glass shaft,

FIG. 8 shows the clamping insert from FIGS. 6 and 7 in a perspective illustration,

FIG. 9 shows the hollow glass shaft passing through the hub of the rotary drive, in the region of a sealing ring which serves as a floating ring seal and which is tension-mounted by means of an outer tension-mounting margin between the cooler-side connection piece and a drive housing of the rotary drive and bears sealingly with an inner ring zone against the rotating hollow glass shaft,

FIG. 10 shows the sealing ring from FIG. 9 in a perspective illustration, and

FIG. 11 shows the rotary evaporator from FIG. 1, illustrated as a detail, in the region of its operating elements designed as a remote control.

### DETAILED DESCRIPTION OF THE PREFERRED EMBODIMENTS

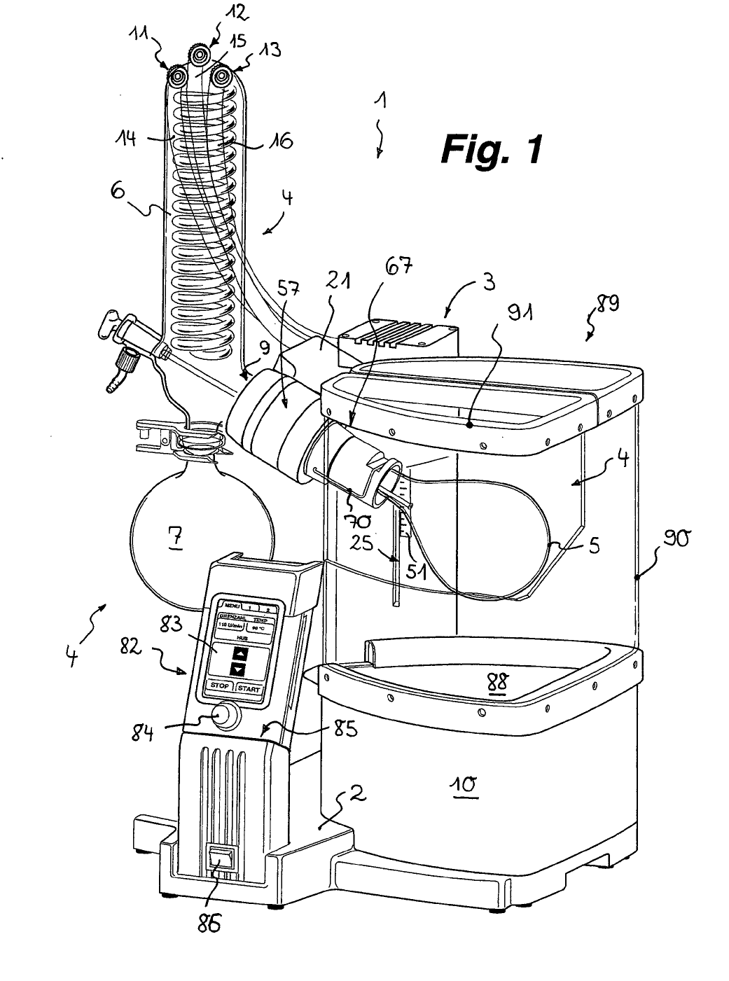

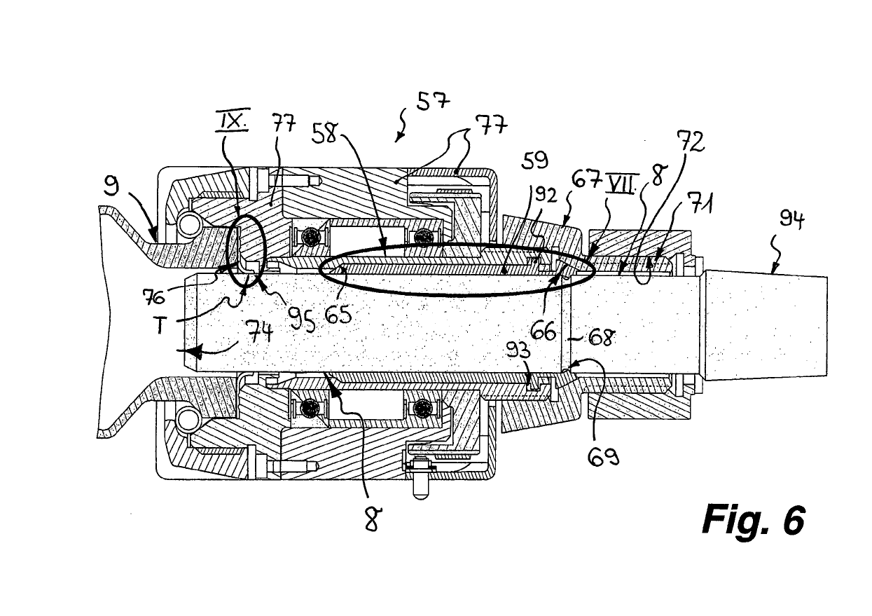

FIG. 1 illustrates a rotary evaporator 1 in a perspective view. The rotary evaporator 1 has an appliance stand 2 which carries the structure of the rotary evaporator. A guide tower 3 projects on the appliance stand 2 and has a vertically oriented longitudinal axis. The rotary evaporator 1 has a glass superstructure 4 which comprises an evaporation vessel 5, designed as an evaporator piston here, a cooler 6 and a collecting vessel 7 connected releasably to the cooler 6. In this case, the evaporation vessel 5 is held on a hollow glass shaft 8 which serves as a vapor leadthrough and is illustrated in more detail in FIGS. 6, 7 and 9 and which issues at its shaft end facing away from the evaporation vessel 5 in a connection piece 9 of the cooler 6.

The rotary evaporator 1 has a temperature control vessel 10 which is designed here as a heating bath and into which the evaporation vessel 5 dips in regions. So that the evaporation vessel 5 can be positioned with a subregion in the temperature control vessel 10 and so that the evaporation process can be interrupted, if required, by the removal of the evaporation vessel 5 from the temperature control vessel 10, the glass superstructure 4 and, with it, the evaporation vessel 5 are held movably on the guide tower 3.

The temperature control vessel 10, designed here as a heating bath, contains, for example, a heated water or oil volume. The evaporation vessel 5 rotates in the heated water or oil quantity of the temperature control vessel 10 and in its piston-shaped inner space contains the solution to be evaporated. This solution is distributed to the heated vessel inner walls of the rotating evaporation vessel 5 as a thin liquid film which can easily evaporate there. As a result of the rotation of the evaporation vessel 5, a delay in boiling is also avoided, and, in conjunction with the heating bath 10 located in the temperature control vessel 10, homogeneous temperature distribution is achieved in the medium to be evaporated. The additionally caused full mixing of the heating bath makes it appreciably easier to regulate the effective heating temperature. To avoid high temperatures which entail risks for the user and may also give rise to unwanted chemical reactions in the medium, the evaporation process is assisted by an evacuation of the process space. The evaporator performance is varied by means of the heating bath temperature, the size of the evaporation vessel 5 and its rotational speed and also the set vacuum pressure. On account of the general inertia of the temperatures of the medium and process, evaporation is controlled primarily at constant temperatures via the pressure. So that the process space can be evacuated and in order to implement a coolant inflow and outflow 6, at least one hose connection and usually a plurality of hose connections 11, 12, 13 is provided on the glass superstructure, also comprising the evaporation vessel 5, of the rotary evaporator and are connected in each case via a flexible hose line 14, 15, 16 to a vacuum pump or to the coolant inflow and outflow.

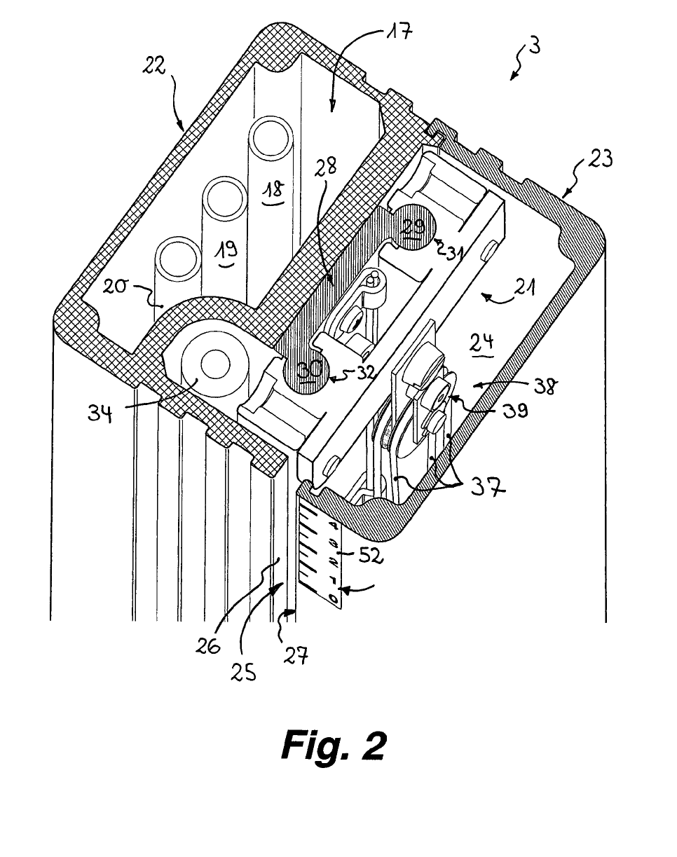

It becomes clear from the perspective cross-sectional illustration in FIG. 2 that the guide tower 3 has a duct 17 which is oriented in the longitudinal extent of said guide tower and in which a line portion of at least one fluid line connected to the glass superstructure 4 is provided. The at least one fluid line ends in a hose connection which is assigned to it, but is not illustrated any further here, and which is arranged on a bottom-side region, facing away from the free end of the guide tower 3, of the rotary evaporator. Since a comparatively long line portion of the at least one fluid line is therefore led in the duct 17 of the guide tower 3, that line portion of this fluid line which is laid freely outside the guide tower 3 and is designed here as the hose line 14, 15 or 16 can be kept comparatively short. The risk of inadvertent entanglement in these freely laid hose lines 14, 15, 16 is consequently minimized. Since the at least one fluid line is led downward inside the guide tower 3, the connections of these fluid lines can be arranged on unmoved parts of the structure in the bottom-side region, facing away from the free end of the guide tower 3, of the rotary evaporator 1. In the rotary evaporator illustrated here, the connections of the fluid lines are arranged in the bottom plate of the appliance stand 2.

So that, for example, the fluid line leading to a vacuum pump and also the fluid lines provided as coolant inflow and outflow, and therefore a plurality of fluid lines, can be led in the duct 17 of the guide tower 3, there is provision whereby the line portions led in the duct are designed as hose lines 18, 19, 20. In this case, the hose lines 18, 19, 20 led in the duct 17 and serving as a line portion are also connected at their line portion end facing away from the bottom-side first hose connection to a second hose connection, likewise not illustrated here, which is arranged at the free end region of the guide tower 3.

So that the glass superstructure 4 can be moved in the vertical direction, and so that its evaporation vessel 5 can be lowered into the temperature control vessel 10 and also raised out of the temperature control vessel 10 again, the glass superstructure is held on a holding device designed as a carriage or having a carriage 21. The carriage 21 can be moved laterally on the guide tower 3. Since the guide tower 3 therefore remains unmoved, the parts moved when the evaporation vessel 5 is being raised and lowered can be minimized.

The guide tower 3 is formed from at least two profile portions 22, 23 which are connected to one another preferably releasably in a parting position oriented in the longitudinal extent of the guide tower 3. In this case, the guide tower 3 has a profile portion 22 designed as a hollow profile, at least one hollow profile inner space of which forms the duct 17 of the guide tower 3. The profile portions 22, 23 of the guide tower 3 delimit a cavity 24 which is designed to be open at a guide slot 25 oriented in the vertical direction. The guide slot 25 is arranged, in the parting position, between the profile portions 22, 23 and is delimited by the adjacent narrow margins 26, 27 of these profile portions 22, 23. The carriage guide 28 assigned to the carriage 21 is provided in the cavity 24. This carriage guide 28 has two guide bars 29, 30 of round cross section which are spaced apart from one another transversely to the direction of guidance and which are surrounded by guide holes 31, 32 in the carriage 21.

The carriage 21 carries at least one connecting arm 33 which passes through the guide slot 25 and which is connected to the glass superstructure 4. The carriage 21 can be moved from a raised position counter to the restoring force of at least one gas pressure spring 34 into a lowered position. For moving the carriage 21, a rope winch 35 is provided which serves as a lifting drive and which is held fixedly with respect to the guide tower 3 on the structure of the rotary evaporator 1. The rope winch 35 has a rope 37 which can be wound onto a rope drum 36 and which is guided on the carriage 21 in such a way that, by the rope 37 being wound up and unwound and by the rope portion which projects beyond the rope winch 35 being shortened and lengthened, the carriage 21 can be raised by the restoring force or can be lowered counter to the restoring force. In the event of a power failure, the rope winch 35 releases the rope 37 wound on it, in such a way that the restoring force can move the carriage 21 into the raised position; since, in the event of a power failure, the carriage 21 can thus be moved automatically into its raised position in which the evaporation vessel 5 is located at a distance above the temperature control vessel 10, the process taking place in the evaporation vessel 5 is interrupted as a precaution, and uncontrolled overheating of the liquid to be evaporated is reliably prevented.

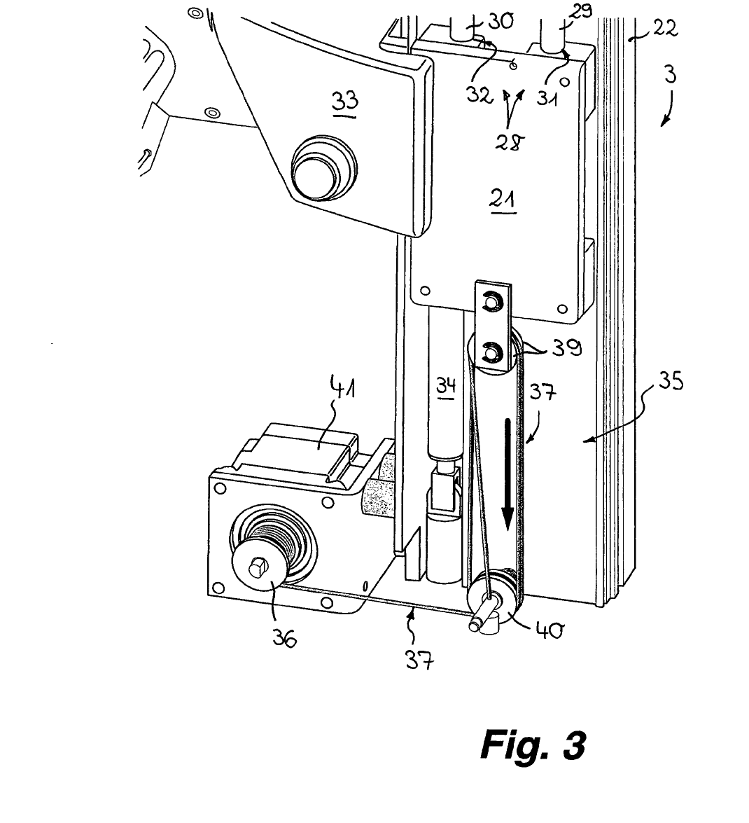

It can be seen in FIG. 3 that the rope 37 of the rope winch 35 is guided via a pulley block 38, said pulley block 38 having deflecting rollers 39, 40 spaced apart from one another. The pulley block 38 has a step-up here. The rope winch 35 has a stepping motor as the electric drive 41. Since this stepping motor has a comparatively high torque, an additional gear is unnecessary. Since the drive shaft of the electric drive 41 is virtually torque-free when the motor is switched off, a reliable emergency switch-off can be ensured even in the event of a power failure, in that the at least one gas pressure spring 34 serving as a restoring force moves the carriage 21 into the upper raised position. In this case, the at least one gas pressure spring 34 presses the carriage 21 against an upper limit stop in the upper raised position. With the aid of an adjustable lower stop, the dipping depth of the evaporation vessel 5 in the heating bath of the temperature control vessel 10 can be set as a function of the size and filling quantity of the selected evaporation vessel 5. With the aid of the stepping control of the electric drive 41, the carriage 21 can be moved in any desired lifting position. In this case, the upper limit stop serves as a reference for the stepping control of the electric drive 41.

The lifting mechanism, which is formed by the rope winch 35, the electric drive 41 and the pulley block 38 and which serves at the start and end of the process for lowering and lifting out the evaporation vessel 5 and for the fine setting of the dipping depth of the latter in the heating bath, is distinguished by a comparatively long lifting travel which, even when large evaporation vessels 5 are used, ensures that these are lifted out of the temperature control vessel 10 completely. The rotational speed of the electric drive 41 assigned to the rope winch 35 is variable and has at least two rotational speed stages. While a high rotational speed ensures a high speed of movement of the carriage 21 for rapidly lowering or lifting out the evaporation vessel 5, a comparatively lower rotational speed achieves a lower speed of the carriage 21 which is intended for the fine setting of the dipping depth of the evaporation vessel 5.

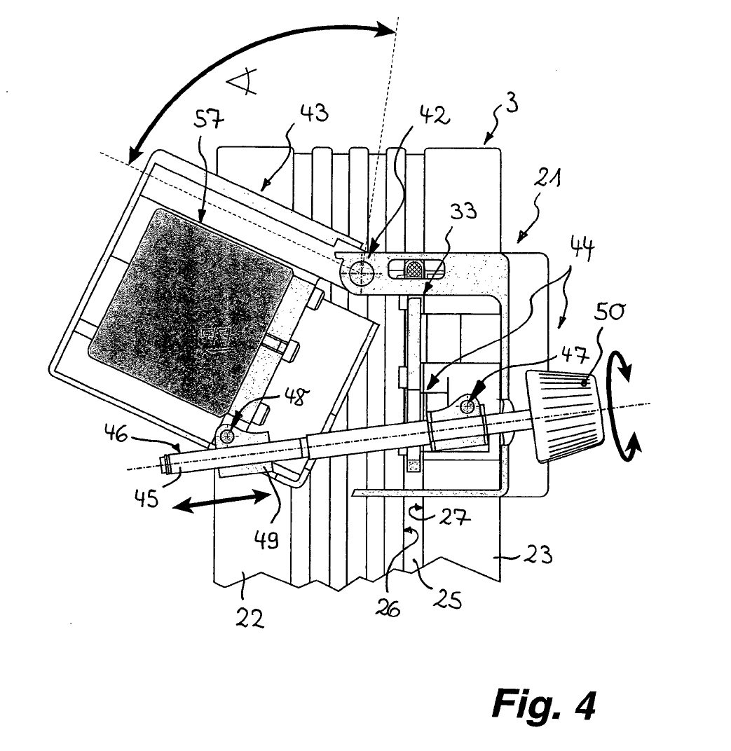

It becomes clear from FIG. 4 that the carriage 21 here is an integral part of a holding device which serves for fastening the glass superstructure 4 to the carriage 21. The glass superstructure 4 illustrated in more detail in FIGS. 1 and 6, and, in particular, its evaporation vessel 5 are held pivotably about a horizontal pivot axis 42 on the holding device. For this purpose, the holding device has a holding part which is designed here as the carriage 21 and on which a carrying part 43 connectable to the evaporation appliance 5 is held pivotably about the horizontal pivot axis 42. To set and fix the selected pivoting position, a spindle drive 44 is provided which has an adjusting spindle 45 with a self-locking spindle thread 46. By this adjusting spindle 45 being rotated, the pivot angle between the holding part designed as a carriage 21 and the carrying part 43 of the holding device can be changed and the pivoting position of an evaporation vessel 5 fastened to the carrying part 43 can be varied. Since the adjusting spindle 45 has a self-locking spindle thread 46, there is no need for an additional and possibly also inadvertently released securing device. The spindle drive 44 makes it possible to adapt the rotary evaporator 1 to the different dimensions of the various evaporation vessels. The carrying part 43 of the holding device carries the entire glass superstructure 4, the center of gravity of which lies far off-center. Without the self-locking of the spindle thread 46 there would be the risk that, when an alternative lock is released, the glass superstructure falls, without being braked, into the lower stop and is broken, and when the glass superstructure is under a vacuum there could additionally be the risk of implosion.

It can be seen in FIG. 4 that the adjusting spindle 45 is held pivotably preferably about a horizontal pivot axis 47, 48 on the holding part designed as a carriage 21 and on the carrying part 43. The adjusting spindle 45, which is mounted pivotably, but immovably in the axial direction, on the holding part designed as the carriage 21, cooperates with a spindle nut 49 which is held pivotably about the pivot axis 48 on the carrying part 43. The adjusting spindle 45 has at one spindle end an adjusting wheel 50 which serves as a handle. The speed of adjustment and the effort required can be optimized via the selection of the type of thread of the adjusting thread 46 and the pitch. Since the adjusting thread 46 is of the self-locking type, there is no need for any further lock which otherwise, when released, entails the risk that the glass superstructure inadvertently falls into the stop and is broken. A spindle drive 44, by means of which the tilt angle of the evaporation vessel 5 can be varied continuously, can be actuated at the adjusting wheel 50 even with only one hand. In conjunction with the variable dipping depth of the evaporation vessel 5 into the temperature control vessel 10 and with the displaceability, described in more detail further below, of the temperature control vessel 10, the pivoting mechanism shown in FIG. 4 makes it possible that a wide range of evaporation vessels 5 of different size, and with a variable filling quantity, can be used.

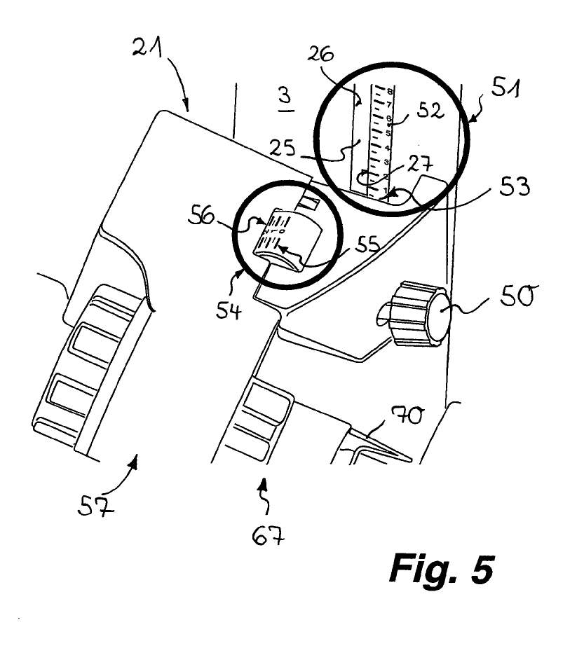

It becomes clear from a comparison of FIGS. 1 and 5 that the carriage 21 movable in the vertical direction on the guide tower 3 can be positioned by means of a scaling 51 having a scale 52 which is provided on the outer circumference of the guide tower 3 and which cooperates with an indicator located on the carriage 21. While the scale 52 is arranged on the outer marginal wall region, adjacent to the guide slot 25, of the guide tower 3, the adjacent edge 53 of the carriage 21 serves as an indicator of the respective lift height.

For positioning the carrying part 43, a further scaling 54 is provided which is provided between the carriage 21 serving as a holding part and the carrying part 43. This scaling 54, too, has a scale 55 which is provided here on the carriage 21. This scale 55 is assigned an indicator which is arranged on the carrying part 43. The indicator is formed here by the adjacent edge 56 of the carrying part 43. With the aid of the scaling 54, the respective pivot angle of the glass superstructure 4 held on the guide tower 3 by means of the holding device can be measured. The scalings 51, 54 make the reproducibility of a test set-up substantially easier and are conducive to the simple handling of the rotary evaporator 1 illustrated here.

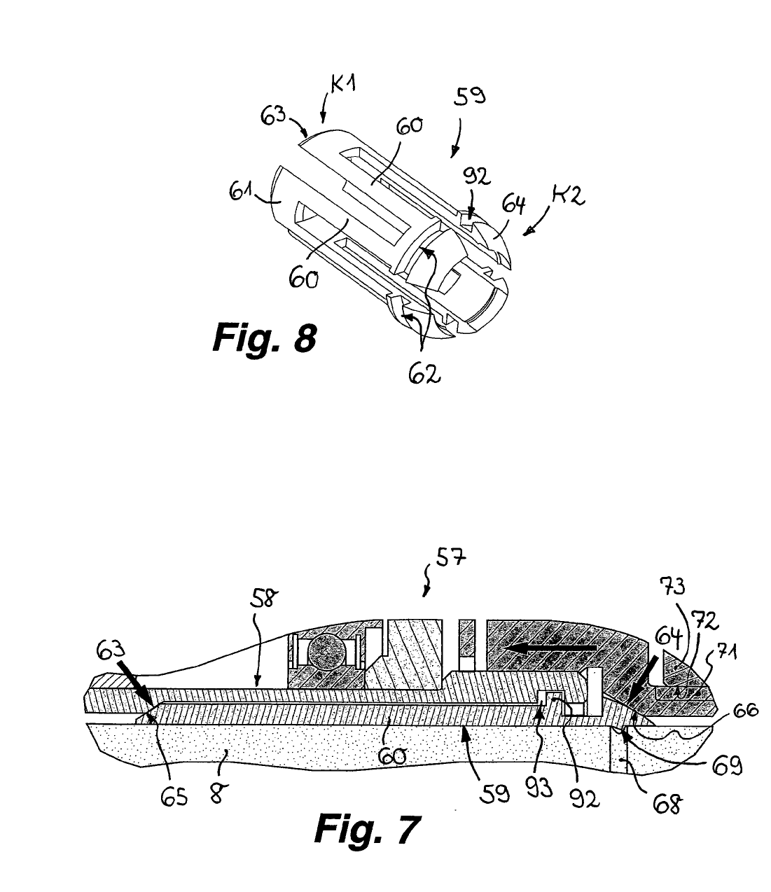

FIG. 6 illustrates the rotary evaporator 1, as a detail, in longitudinal section in the region of its rotary drive 57 provided on the carrying part 43 of the holding device. The rotary drive 57 has a hub 58 which can be driven in rotation by means of an electric drive motor. The drive motor, not shown any further, of the rotary drive 57 is configured here as a brushless direct current motor with toothed belt step-up. So that the rotational movement of the hub 58 can be transmitted to the hollow glass shaft 8 carrying the evaporation vessel 5, the clamping insert 59, illustrated in more detail in FIGS. 7 and 8, is pushed onto this hollow glass shaft 8. The clamping insert 59 intended for clamping the hollow glass shaft 8 in the hub 58 has a sleeve-like basic shape. For this purpose, the clamping insert 59 has supporting bars 60 which are oriented in the longitudinal direction and which are connected to one another via connecting webs 61, 62 oriented in the circumferential direction of the clamping insert 59. The connecting webs 61, 62 alternately connect the web ends, arranged on one side of the clamping insert 59 or the other, or adjacent to supporting webs 60, in such a way that each supporting web 60 is connected to its one adjacent supporting web via a connecting web 61 arranged on one side of the clamping insert 59 and projecting in one circumferential direction, while said supporting web is connected to the other adjacent supporting web via a connecting web 62 located on the other side of the clamping insert 59 and projecting in the opposite circumferential direction. In this case, the connecting webs 61, 62 provided at the opposite ends of the clamping insert 59 form clamping portions K1 and K2 of the clamping insert 59 which are spaced apart from one another. The connecting webs 61, 62 forming the clamping portions K1 and K2 taper toward the free ends of the clamping insert 59 in such a way that the clamping portions K1 and K2 in each case carry at least one clamping slope 63, 64 sloped in relation to the longitudinal axis of the clamping insert 59, said clamping slopes cooperating with counterslopes 65 and 66 of the rotary drive 1 which are assigned to them, in such a way that the clamping portions K1 and K2 are pressed against the hollow glass shaft 8 when pressure acts axially upon the clamping insert 59. Since the clamping insert 59 has a loop-shaped or meander-like outer contour due to the supporting webs 60 and to the connecting webs 61, 62 provided alternately at the opposite end regions of the supporting webs 60, and since this outer contour of the clamping insert 59 can, if required, be widened in circumference in a simple way, the clamping insert 59 can easily be positioned on the hollow glass shaft 8.

It becomes clear from FIG. 6 and from the longitudinal section in the form of a detail in FIG. 7, which shows the region identified in FIG. 6 by VII, that the clamping insert 59 can be inserted from that side of the hub 58 which faces the evaporation vessel 5 into said hub as far as an annular step, formed as a counterslope 65, on the inner circumference of the hub 58, and that, for pressure to act axially upon the clamping insert 59, a tension screw ring 67 can be screwed releasably onto the hub 58 and acts with a counterslope 66 provided on the inner circumference of the tension screw ring 67 upon that clamping portion K2 of the clamping insert 59 which projects beyond the hub 58.

Since the clamping insert 59 has a loop-shaped or meander-like outer contour due to the supporting webs 60 and to the connecting webs 61, 62 provided alternately at the opposite end regions of the clamping insert 59, and since this outer contour of the clamping insert 59 can, if required, be widened in circumference in a simple way, the clamping insert 59 can easily be positioned on the hollow glass shaft 8. The flexibility of the clamping insert 59 is achieved by means of the narrow supporting webs 60 running axially and by the connecting webs 61, 62 connecting them. By contrast, in the regions where force is transmitted, to be precise in the clamping portions K1 and K2, the clamping portion 59 is designed with a large area, in order to achieve areal clamping of the hollow glass shaft 8 serving as a vapor leadthrough. The frictional connection arising fixes the hollow glass shaft 8, free of play, in the hub 58 of the rotary drive 57. On the outer circumference of the clamping insert 59, a continuous nose 92 is provided, which is designed here as an (interrupted) annular flange which engages into an annular groove 93 on the inner circumference of the hub 58 and secures the clamping insert 59 axially in the hub 58. Thus, when the hollow glass shaft 8 is being demounted, the clamping insert 59 remains in the hub 58, and the tension screw ring 67 is merely released and does not have to be removed in order to remove the hollow glass shaft 8 from the hub 58 of the rotary drive 57.

It can be seen in FIGS. 6 and 7 that the hollow glass shaft 8 carries on its outer circumference a shaped-in portion 68 which is designed as an annular groove and which is assigned a shaped-out portion 69, designed as an annular bead, on the inner circumference of the clamping insert 59. Since the shaped-out portion 69 provided on the clamping insert 59 is arranged in that subregion of the clamping insert 59 which projects beyond the hub 58 and, in particular, on the inner circumference of the clamping portion K2 projecting beyond the hub 58, the hollow glass shaft 8 can even at a later stage still be pushed into the clamping insert 59 located in the hub 58 or pulled out there, for example when an exchange of the evaporation vessel 5 also makes it necessary to change the hollow glass shaft 8.

It becomes clear from FIG. 6 that the hollow glass shaft 8 serving as a vapor lead-through is plugged through the hub 58 of the rotary drive 57 and clamped in the hub 58 via the clamping insert 59 located between the hub 58 and the hollow glass shaft 8, so that a rotation of the hub 58 of the rotary drive 57 about a longitudinal axis of the hub 58 leads to a corresponding rotation of the clamping insert 59, of the hollow glass shaft 8 and the evaporation vessel 5 connected fixedly in terms of rotation to the hollow glass shaft 8. The hub 58, clamping insert 59 and hollow glass shaft 8 are arranged concentrically to one another. The rotationally fixed connection between the hollow glass shaft 8 and the evaporation vessel 5 is ensured by a ground joint which is preferably designed as a taper-ground joint, in which the hollow glass shaft 8 engages with its side which faces the evaporation vessel 5 and on which a ground spigot 94 is formed into a ground sleeve formed on a vessel neck of the evaporation vessel 5. To secure the ground joint between the hollow glass shaft 8 and the evaporation vessel 5, an additional ground clamp 70 (cf. FIG. 1) may be provided.

It can be seen in FIG. 6 that the tension screw ring 67 carries a thread 71 which cooperates with a counter-thread 72 on a press-off screw ring 73. When the press-off screw ring 73 is unscrewed from the tension screw ring 67, the press-off screw ring 73 presses onto the evaporation vessel 5 and its vessel neck in such a way that the clamping connection or ground joint between the evaporation vessel 5 and the hollow glass shaft 8 carrying the evaporation vessel 5 is released.

The hollow glass shaft 8 designed as a vapor lead-through reaches with its shaft end facing away from the evaporation vessel 5 into the connecting orifice 74 of the connection piece 9 leading to the cooler 6 and is sealed off with respect to this connection piece 9 by means of a floating ring seal illustrated in more detail in FIGS. 6, 9 and 10. This floating ring seal is formed by a sealing ring 76 which is tension-mounted between the connection piece 9 and a drive housing 77 of the rotary drive 57 and which bears sealingly against the rotating hollow glass shaft 8. The sealing ring 76 is designed as an annular disk, the outer annular zone 78 of which serves as a tension-mounting margin. The annular disk has an annular zone 79 bent round in the longitudinal extent of the hollow glass shaft 8, so that the sealing ring 76 bears sealingly with a subregion T, oriented in the longitudinal direction of the hollow glass shaft, of the annular disk. In this case, the subregion T, oriented in the longitudinal direction of the hollow glass shaft 8, of the annular disk bears spring-elastically against the hollow glass shaft 8, so that always uniformly good and permanent sealing off is ensured in this region. The sealing ring 76 is formed in one piece and can be produced at low outlay as a material compound. In this case, a Teflon compound is preferred, which is distinguished by a low coefficient of friction and reduced wear.

The sealing ring 76, which has a j-shaped or u-shaped configuration in longitudinal section and of which the inner margin 95 delimiting the annular orifice can be bent outward in the direction facing away from the hollow glass shaft 8, has at its tension-mounting margin at least one annular groove 80 which may be assigned a complementary annular bead 81 on the adjacent end margin of the driver housing 77.

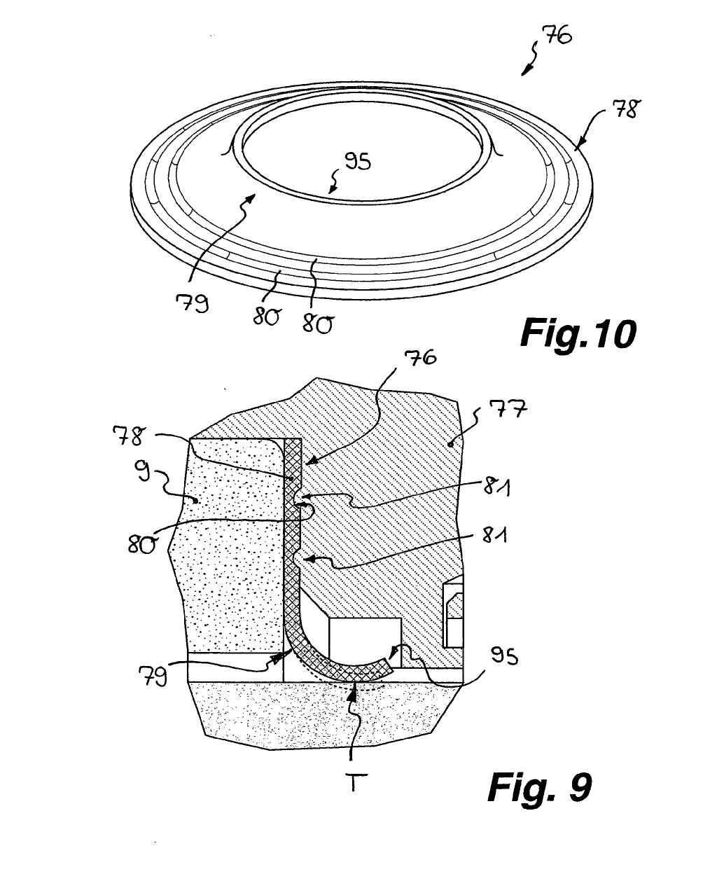

A comparison of the inner annular zone 79 illustrated in FIG. 9, on the one hand, by unbroken lines and, on the other hand, by dashed lines indicates that this annular zone 79 comes to bear under prestress in the direction of the hollow glass shaft 8 in such a way that the sealing ring 76 bearing against the hollow glass shaft 8 is thereby readjusted automatically in the event of wear.

The clamping insert 59 is preferably designed as a plastic part and, in particular, as a plastic injection molding. Since, in the region of the inner annular zones 79 of the sealing ring 76, the glass of the hollow glass shaft 9, the clamping insert 59 produced particularly from plastic and the preferably metallic hub 58 of the rotary drive 57 bear one against the other under pressure force, such a choice of material for these individual parts 9, 59, 58 constitutes the ideal combination between softness, rigidity and frictional engagement of these individual parts rotating with one another.

The rotary drive 57 is assigned a motor control, not illustrated any further, which preferably has a continuous rotational speed setting, particularly with the possibility of reversal of direction of rotation. To avoid the adhesion of solid residues to the vessel inner wall, particularly during a drying process, it may be expedient to have an operating mode which provides a periodic reversal of direction of rotation. In order to bring about a safety switch-off of the rotary evaporator 1 in the event of a blockage of the rotational movement, monitoring of the motor current is provided. At the commencement of the rotational movement, a smooth start of the rotary drive 57 is provided, for which purpose its motor control has stored in it a corresponding starting characteristic curve which, for example, will provide a limitation of the motor current.

The temperature control vessel 10 serves for the controlling of temperature of the liquid bath located in the temperature control vessel 10 and, in particular, for the controlled feed of heat into the evaporation vessel 5. For this purpose, the temperature control vessel 10 has an electrical temperature control device and, in particular, an electrical heating device. The oil or water used as temperature control liquid is circulated as a result of the rotation of the evaporation vessel 5, in such a way that homogeneous temperature distribution is ensured. The inertia of the bath temperature stabilizes the heating temperature when boiling commences in the evaporation vessel 5 (evaporation cold).

So that the temperature control vessel 10 can be filled and emptied in a simple way, the temperature control vessel 10 is placed releasably onto the appliance stand 2 of the rotary evaporator. The appliance stand 2 is sufficiently stable to rule out the tipping over of the rotary evaporator 1, even when the temperature control vessel 10 is removed. At least one positioning projection is provided on the appliance stand 2 or on the temperature control vessel 10 and cooperates with an assigned shaped-in positioning portion on the temperature control vessel 10 or on the appliance stand 2. The rotary evaporator 1 preferably has two such positioning projections which cooperate in each case with a shaped-in positioning portion and project, for example, in the manner of a tenon and one of which is intended for the electrical contacting of the temperature control device provided in the temperature control vessel 10 with an electrical terminal on the appliance stand and the other positioning projection of which is intended for contacting the signal connection between the rotary evaporator 1 and a temperature sensor integrated into the temperature control vessel 10.

An electrical coupling is arranged in the region of the positioning projection and shaped-in positioning portion, which are movable approximately axially parallel to the axis of rotation of the rotary drive 57, and is intended for the electrical contacting of the temperature control device provided in the temperature control vessel with an electrical terminal on the appliance stand. So that the position of the evaporation vessel 5 can be varied in relation to the appliance stand 2 and so that evaporation vessels 5 of different size can be used in the rotary evaporator 1, the at least one positioning projection provided on the appliance stand 2 or shaped-in positioning portion thereon is held movably by means of a sliding guide not illustrated any further here. This sliding guide has at least two sliding parts which are guided telescopically one in the other and one sliding part of which is held immovably on the appliance stand 2 and another sliding part of which carries the at least one positioning projection or the at least one shaped-in position portion.

It becomes clear from FIG. 1 that the temperature control vessel 10 has an approximately triangular basic shape at least in its clear inner cross section and preferably also in its outer cross section. In order to counteract sloshing of the temperature control liquid located in the temperature control vessel 10 during operation and when the temperature control vessel 10 is being transported, the temperature control vessel 10 has vertically oriented, that is to say largely perpendicular vessel inner walls 88, with the exception of the region of a pour-out spout 87. The pour-out spout 87 is provided in the prolongation of the apex 75 of the triangular basic shape, the apex 75 being oriented in the direction facing the evaporation vessel 5. On the outer circumference of the temperature control vessel 10, ergonomic grip recesses are provided, at which the temperature control vessel can easily be grasped. A scale, preferably provided on at least one of the vessel inner walls 88, indicates the filling height of the temperature control liquid. Since the temperature control vessel 10 is displaceable along the axis of rotation, a wide range of evaporation vessels can be used. Even larger evaporation vessels 5 can dip into the temperature control vessel 10 because this is configured to have an appropriate depth. A transparent covering hood 89 can be placed on the temperature control vessel 10. The covering hood 89 has at least one first hood part 90 which can be set down on the upper narrow margin of the temperature control vessel 10 and on which at least one second hood part 91 is held in a pivotable or swing-open manner. Since the evaporation vessel 5, which is mostly under a vacuum during operation, is produced from uncoated glass for the purpose of an improved transfer of heat in the liquid bath, and since preferably only the other components of the glass superstructure 4 are comprised of break-proof glass or glass having an anti-splinter coating, the covering hood 89 serves as protection against splintering.

The temperature control vessel 10 has a filling level sensor control-connected to a metering pump which is connected to a temperature control liquid reservoir. The filling level sensor is an integral part of a filling level monitoring system which brings about an emergency switch-off when a temperature liquid minimum is undershot. The filling level sensor may additionally or instead also be an integral part of a filling level regulating system which is intended for the compensation of evaporation losses.

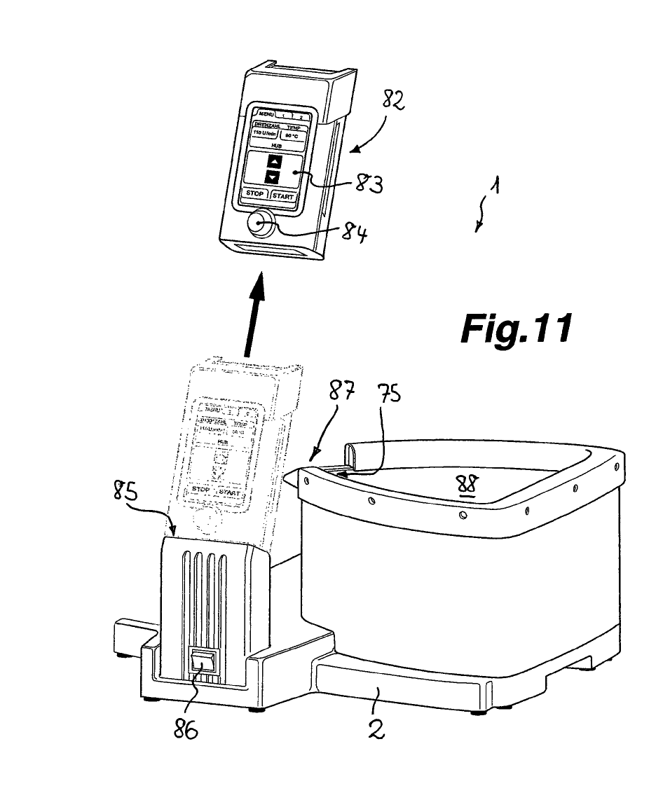

It becomes clear from a comparison of FIGS. 1 and 11 that the rotary evaporator 1 is operated via a central operating unit 82 which allows direct access to all technical functionalities and therefore, inter alia, also to the rotary drive 57, lifting drive and temperature control device provided in the temperature control vessel 10.

So that the rotary evaporator 1 can be operated even when it is located in a protected manner, for example, in a fume cupboard, the operating unit 82 is designed as a preferably wireless remote control unit releasable from the rotary evaporator 1. A data transmission interface, which may be designed, for example, as a USB interface, makes it possible to process control and/or documentation of the process parameters on an external data processing installation and, in particular on a PC. The remote control unit 82 which can be used as wireless remote control has a display 83 which is preferably configured as a touch screen with intuitive operating elements adapted to the operating mode. An operative button 84, designed here as a push-and-turn button, is provided on the operating unit 82 as a further operating element which may be used, for example, for the input of numerical values.

On the rotary evaporator 1, a console or repository 85 for the operating unit 82 is provided, which, with the operating unit 82 deposited, ensures an optimal operating height of the operating elements and display 83 and which, for this purpose, projects above the appliance stand 4. The rotary evaporator according to the invention can selectively either be operated directly by the remote control unit 82 located on the console 85 or also be actuated at a distance via the remote control unit 82. A power switch 86, which can also be used as an emergency off switch, is arranged on the front side of the rotary evaporator 1 so as to be easily reachable.

The display 83 configured as a touch screen serves, for example, for indicating the actual temperature in the liquid bath, the desired temperature of the temperature control device integrated into the temperature control vessel 10 and the rotational speed of the rotary drive or for indicating comparable process parameters. So that the control functions shown on the display 83 can be selected and/or so that the process parameters can be varied, the operating button 84 may also be used additionally or instead. In order to organize as simply as possible the operation of the control device which is preferably located in the rotary evaporator 1 and may also comprise the motor control for the rotary drive 57, individual functions of the control device are arranged in a menu structure capable of being illustrated on the display 83, scrolling through the individual menus being carried out by means of the operating button 84 and/or the display 83 designed, where appropriate, as a touch screen.

The repository or console 85 projecting on the rotary evaporator 1 above the appliance stand 4 of the latter is provided for supporting or depositing the remote control unit 82. The repository or console 85 has at least one contact system which is connectable releasably to the operating unit 82 and which is intended for feeding current to the charging system for the accumulators located in the operating unit 82 and preferably also to the conductor-based control connection between the at least one operating element 83, 84 of the operating unit 82 and the control device, the wireless control connection being switched off. When the operating unit 82 relies on the repository or console 85, the wireless control connection is provisionally set in favor of a conductor-based control connection between the at least one operating element 83, 84 provided on the operating unit 82 and the control device.

The control device of the rotary evaporator 1 also has an emergency off function, the triggering of which interrupts the feed of current to the temperature control device in the temperature control vessel 10 and triggers the upward movement of the glass superstructure 4 held movably on the guide tower 3 into the position of rest. In this case, the emergency off function stored in the control device may be triggered, for example, manually at a special emergency off switch on the operating unit 82 or at the power switch 86 of the rotary evaporator 1 or else automatically, when the operating unit 82 is no longer supplied with current or the wireless control connection between the remote control unit 82 and the rotary evaporator 1 is interrupted. Since the feed of current to the temperature control device in the temperature control vessel 10 is interrupted, there is no fear of any further uncontrolled heating of the test set-up. Since the evaporation vessel 5 is also moved out of the operating position located in the liquid bath into the position of rest provided outside the temperature control vessel 10, the liquid contained in the evaporation vessel 10 cannot inadvertently be heated by the residual heat contained in the liquid bath.

For example, the actual temperature of the temperature control liquid located in the temperature control vessel 10 can also be read off on the display 83 of the operating unit 82. The required desired temperature of the temperature control liquid located in the temperature control vessel 10 can be stipulated via the display 83 designed as a touch screen and/or via the operating button 84. In the same way, a change in direction of rotation of the rotary drive 57 can be stipulated, preferably at preselectable time interfaces, for the control device. Finally, it can also be stipulated via the operating unit 82 how far the evaporation vessel 5 of the glass superstructure 4 is to be moved down on the guide tower 3, while fine adjustment of the dipping depths of the evaporation vessel 5 in the temperature control vessel 10 may also be possible by turning the operating button 84.

As a result of the heating of the evaporation vessel 5 in the liquid bath of the temperature control vessel 10, the solution contained in the evaporation vessel 5 evaporates and the vapor flows through the hollow glass shaft 8 serving as a vapor lead-through into the connection piece 9 leading to the cooler 6. The vapor can condense in the cooler 6 and flow out into the collecting vessel 7. Separation of material constituents is achieved in that their boiling points differ from one another, so that, at a stipulated temperature, specific materials can evaporate, while other materials for the time being still remain in the evaporation vessel. By a vacuum being applied to the glass superstructure 4, the boiling temperature can be lowered, with the result that higher-boiling solvents can be evaporated at a lower temperature than will be the case at normal pressure. Substances which are temperature-sensitive can also be distilled in the glass superstructure 4 which is under a vacuum. The decomposition of such temperature-sensitive substances can be prevented by working at a lower boiling temperature. The sealing ring 76 serving as a floating ring seal in this case seals off the rotating hollow glass shaft 8 with respect to atmospheric pressure and thus ensures that the vacuum is maintained inside the glass superstructure 4. Since the inside diameter of the sealing ring 76 is somewhat smaller than the diameter of the hollow glass shaft 8 in this region, pre-stressing of the sealing ring 76 occurs and is increased further by the pressure difference prevailing at the sealing ring. When the sealing ring 76 is worn as a result of abrasion, the floating ring seal readjusts itself on account of the prestress of the sealing ring 76. The annular beads 81 provided on the drive housing 77 press the sealing ring annularly against the connection piece 9, specifically in such a way that the rise in surface pressure along these two closed lines additionally ensures optimal sealing off.

The evaporation process is ended by means of a controlled switch-off which takes place independently of the current supply when the evaporation vessel 5 is lifted out of the temperature control vessel 10, in the event of a stop in the rotation of the rotary drive 57, when the vacuum generated in the glass superstructure 4 is abruptly cancelled or when the cooling of the cooler 6 is switched off, for this purpose the cooler 6 being assigned an interface for a switching valve. A switch-off of the rotary evaporator 1 and therefore an ending of the evaporator process can be triggered by a user, by a stipulated process parameter (process end) being reached, by a process error or a power failure.

### LIST OF REFERENCE SYMBOLS

Rotary evaporator 1
Appliance stand 2
Guide tower 3
Glass superstructure 4
Evaporation vessel 5
Cooler 6
Collecting vessel 7
Hollow glass shaft 8
Connection piece (of the cooler) 9
Temperature control vessel 10
Hose connection (on the glass superstructure) 11
Hose connection (on the glass superstructure) 12
Hose connection (on the glass superstructure) 13
Hose line (laid freely) 14
Hose line (laid freely) 15
Hose line (laid freely) 16
Duct 17
Hose line (in the guide tower) 18
Hose line (in the guide tower) 19
Hose line (in the guide tower) 20
Carriage 21
Profile portion (hollow profile) 22
Profile portion 23
Cavity (between the profile portions) 24
Guide slot 25
Narrow margin (of the profile portion 22) 26
Narrow margin (of the profile portion 23) 27
Carriage guide 28
Guide bar (of the carriage guide 28) 29
Guide bar (of the carriage guide 28) 30
Guide hole (in the carriage 21) 31
Guide hole (in the carriage 21) 32
Connecting arm 33
Gas pressure spring 34
Rope winch 35
Rope drum 36
Rope 37
Pulley block 38
Deflecting rollers (of the pulley block) 39
Deflecting rollers (of the pulley block) 40
Electric drive (of the rope winch) 41
Pivot axis (of the holding device) 42
Carrying part (of the holding device) 43
Spindle drive 44
Adjusting spindle 45
Spindle thread 46
Pivot axis (of the adjusting spindle on the holding part) 47
Pivot axis (of the spindle nut) 48
Spindle nut 49
Adjusting wheel 50
Scaling (for lift height) 51
Scale (of the scaling 51) 52
Edge (of the carriage 21 as an indicator of the lift height) 53
Scaling (for the pivot angle) 54
Scale (of the scaling 54) 55
Edge (on the carrying part 43 as an indicator of the scaling 54) 56
Rotary drive 57
Hub 58
Clamping insert 59
Supporting webs 60
Connecting webs (left) 61
Connecting webs (right) 62
Clamping slope (left) 63
Clamping slope (right) 64
Counterslope (in the hub) 65
Counterslope (in the tension screw ring) 66
Tension screw ring 67
Shaped-in portion 68
Shaped-out portion 69
Ground clamp 70
Thread (on the tension screw ring 67) 71
Counter-thread (on the press-off screw ring) 72
Press-off screw ring 73
Connecting orifice (for the connection piece) 74
Apex 75
Sealing ring 76
Drive housing 77
Outer annular zone (of the sealing ring) 78
Bent-round annular zone (of the sealing ring) 79
Annular groove (on the sealing ring) 80
Annular bead (on the end margin of the drive housing) 81
(Remote) control unit 82
Display 83
Operating button 84
Repository or console (for operating unit) 85
Power switch 86
Pour-out spout 87
Vessel inner walls of the temperature control vessel 88
Covering hood 89
Fixed hood part 90
Swing-open hub part 91
Nose 92
Annular groove 93
Ground spigot 94
Inner margin 95
Clamping portion (left) K1
Clamping portion (right) K2
Subregion (of the sealing ring) T

1. A rotary evaporator (1) comprising an appliance stand (2), on which a guide tower (3) projects, a glass superstructure (4) which has an evaporation vessel (5) which, for raising and lowering of the evaporation vessel (5), is held on a carriage (21) movable laterally on the guide tower (3), and at least one fluid line which is connected to the glass superstructure (4), the guide tower (3) has a duct (17) which is oriented in a longitudinal extension direction of the tower (3) and in which is provided a line portion of at least one fluid line which is connected to the glass superstructure (4) and which issues or ends in a hose connection which is arranged on a bottom-side region, facing away from a free end of the guide tower (3) and, the guide tower (3) is formed from at least two profile portions (22, 23) which are connected in a parting position oriented in the longitudinal extension direction of the guide tower (3), the guide tower (3) has at least one of the profile portions (22) formed as a hollow profile, and at least one hollow profile inner space of the at least one profile portion (22) forms the duct (17) of the guide tower (3).

2. The rotary evaporator as claimed in claim 1, wherein the at least one line portion provided in the guide tower (3) is connected at a line portion end thereof facing away from a bottom-side first hose connection to a second hose connection which is arranged at a free end region of the guide tower (3).

3. The rotary evaporator as claimed in claim 1, wherein the at least one line portion, provided in the duct (17) of the guide tower (3), of the at least one fluid line is a hose line (18, 19, 20) lead in the duct (17), and the line portion is connected at hose line ends thereof to the first and, if appropriate, a second hose connection.

4. The rotary evaporator as claimed in claim 1, wherein the at least two profile portions (22, 23) of the guide tower (3) delimit a cavity (24) which is open at a guide slot (25), a carriage guide (28), on which the carriage (21) is guided movably, is provided in the cavity (24), and the carriage (21) carries at least one connecting arm (33) which passes through the guide slot (25) and which is connected to the glass superstructure (4).

5. The rotary evaporator as claimed in claim 4, wherein the guide slot (25) is arranged, in a parting position, between the at least two profile portions (22, 23) and is delimited by adjacent narrow margins (26, 27) of the profile portions (22, 23).

6. The rotary evaporator as claimed in claim 1, wherein the carriage (21) is positionable by a scaling (51) having a scale (52) which is provided on an outer circumference of the guide tower (3) and which cooperates with an indicator located on the carriage (21).

7. The rotary evaporator as claimed in claim 1, wherein the carriage (21) is movable from a raised position counter to a restoring force into a lowered position, and to move the carriage (21), a rope winch (35) is fixed with respect to the guide tower (3) and has at least one windable rope (37) which is held or guided on the carriage (21).

8. The rotary evaporator as claimed in claim 7, wherein the at least one rope (37) of the rope winch (35) is guided via a pulley block (38).

9. The rotary evaporator as claimed in claim 7, wherein the rope winch (35) has a drive motor having a sprung or vibration-damping mounting.

10. The rotary evaporator as claimed in claim 7, wherein the rope winch (35) has a drive motor which is an electric drive motor that is torque-free in a currentless state.

11. The rotary evaporator as claimed in claim 7, wherein the rope winch (35) has a drive motor which is a stepping motor.

12. The rotary evaporator as claimed in claim 7, wherein at least one gas pressure spring (34) is provided to generate the restoring force.

13. The rotary evaporator as claimed in claim 12, wherein the at least one gas pressure spring (34) presses the carriage (21) against a sliding stop in a raised position.
